(19) United States
(12) Patent Application Publication
(10) Pub. No.: US 2006/0184784 A1
(43) Pub. Date: Aug. 17, 2006

(54) Method for secure transference of data

(76) Inventor: Yosi Shani, Ra'anana (IL)

Correspondence Address: Angenehm Law Firm. Ltd., P.O. Box 48755, Coon Rapids, MN, 55448-0755, US

(21) Appl. No.: 11/357,625

(22) Filed: Feb. 16, 2006

Related U.S. Application Data
(60) Provisional application No. 60/653,131, filed on Feb. 16, 2005.

(51) Int. Cl. H04L 9/00

(52) U.S. Cl. 713/150

(57) ABSTRACT

An apparatus for the secure transference of data. Said apparatus is hardware-based and enables users to perform data transferring between a first computer to a second computer while ensuring that no direct, real-time link is established between them. The apparatus comprises a storage device, a hardware-based switching unit and a hardware-based control unit. Wherein the control unit is configured to command the switching unit to physically connect the storage device to one computer in a manner that ensures that said storage device is disconnected from the second computer. Thus, data is securely transferred from first computer to said storage device and subsequently securely transferred from said storage device to second computer.

### CROSS-REFERENCE TO RELATED APPLICATIONS

This application is related to U.S. Provisional Patent Application 60/653,131 filed Feb. 16, 2005 and whose disclosure is incorporated herein in its entirety by reference.

### FIELD OF THE INVENTION

The present invention relates in general to systems and methods for secure data transference. More particularly, it relates to systems and methods for automatic offline secure data transference.

### BACKGROUND

Existing methods for transferring data between different computers and networks may be classified into two major types: using online or offline data transferring. The online data transferring is the most common one. In most cases it creates a bidirectional link between the computers that allows sharing data in a quick and seamless manner. The main drawback of his method is that although the great many resources, systems, methods and tools invested to increase the network's level of security, a foolproof solution is yet to be found. It is a very difficult task to secure an online network data transferring because whatever firewall or software-based barrier used, a vivid connection is established between any two components on the network, and data may flow both ways at any time.

In addition, security systems methods and tools for online data transferring are costly, increasing the networks complexity, degrading its performance and in need of frequent security maintenance and updating. In addition, most often networks need to Make use of more then one security means in order to protect themselves against different types of threats.

Offline data transferring methods on the other hand, rely today on manually transferring data from one computer to another using magnetic or optic data storing means. These methods are highly reliable and safe, since no direct link is created at any point between the two computer computers.

The major drawback of this system is that by relying solely on manual manipulation, it offers only a limited, irregular and infrequent data transfer on top of being cumbersome per se.

In addition, by relying on the so-called ‘human factor’, security requirements may be compromised and the secure transference of the data may be reliable only as reliable as the person who deals with said transference.

Several patents are directed to methods and apparatuses that address the challenges of securely transferring data between unconnected computers. None address the overall problem.

U.S. Pat. No. 6,026,502 relates to an apparatus comprising a storage unit based on Random Access Memory (RAM) wherein a system of photo-couplers is functioned to electrically isolate the storage unit from its environment. The main drawback of this reference is that the storage is based upon a volatile memory (RAM). Moreover, the stress in this reference is more on electrical isolation (achieved by the use of photo-couplers) rather than making sure that the system's functionality could not be controlled by external user and/or by software manipulations.

There is therefore a need for a data transference system, which would allow frequent, automatic and regular transference of data while ensuring the security level of offline data transferring.

### SUMMERY OF THE INVENTION

The present invention discloses a new and efficient system for automatically transferring data using offline data communication means. The present invention enables users to establish communication between two computers/networks while ensuring that no direct link is established between them.

The invention suggests using a hardware-based apparatus in order to achieve a secure transference of data between a first computer to a second computer.

Specifically, the transferring apparatus comprises a storage device; a hardware-based switching unit and a hardware-based control unit. Wherein the control unit is configured to command the switching unit to physically connect the storage device to one computer in a manner that ensures that said storage device is disconnected from the second computer. Thus, data is securely transferred from first computer to said storage device and subsequently securely transferred from said storage device to second computer.

Preferably the control unit is incorporated in an IC chip logically separated from the operating systems of the computers and is used for synchronizing between the data transfer operations and so the control unit is not addressable through external communication.

The communication security derives from and inherent to the offline operating mode. Since at any time there is no physical link between the two computers destined for data sharing, no real-time manipulations may take place.

In addition, the present invention suggests using more than one apparatuses according to the present invention configured in serial, and by using a third-party software-based anti-virus, or any other prevention tool against malicious code, enhance the level of security of the data transfer.

Similarly, a parallel configuration is further suggested, wherein several apparatuses according to the present invention are used to achieve a higher data transfer rate.

### BRIEF DESCRIPTION OF THE DRAWINGS

FIG. 1 is a schematic illustration of the environment of the preferred embodiment of the invention;

FIG. 2 shows the basic structure of an embodiment of the invention; and

FIG. 3 shows an elaborate embodiment of the present invention;

### DETAILED DESCRIPTION OF THE INVENTION

The present invention discloses a new apparatus for automatically transferring data using offline data transference means. The invention enables users to establish a connection between two computers/networks while ensuring that no direct link is established between them. By doing so, it protects the transference route from any attempts to make use of it, interfere it or conduct any other malicious activity.

Additionally, the data transference is performed on demand, automatically, and almost in real-time.

One embodiment of the invention comprises a hardware-based switching unit (or relay) mechanism that transfers data between two computers while ensuring that these computers are never physically connected to each other.

Making the separation in the physical level increases the level of security in comparison to other methods and systems that make use of a logical separation for security purposes. This is because a physical separation as opposed to a logical one cannot be overridden.

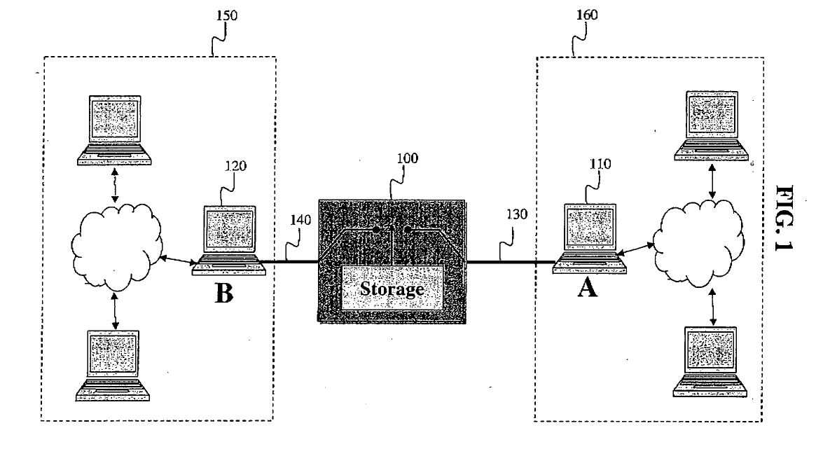

Referring now to FIG. 1, the environment of the present invention is illustrated. The transferring apparatus 100 is connected via data/control links 140, 130 to computer B 120 and computer A 110, respectively. Computer A 110 and computer B 120 may each a part of a computer network, 160 and 150 respectively.

According to the preferred embodiment of the invention, said data/control links 130 and 140 are in the form of USB lines, wherein data and control signals are combined in accordance with the USB protocol.

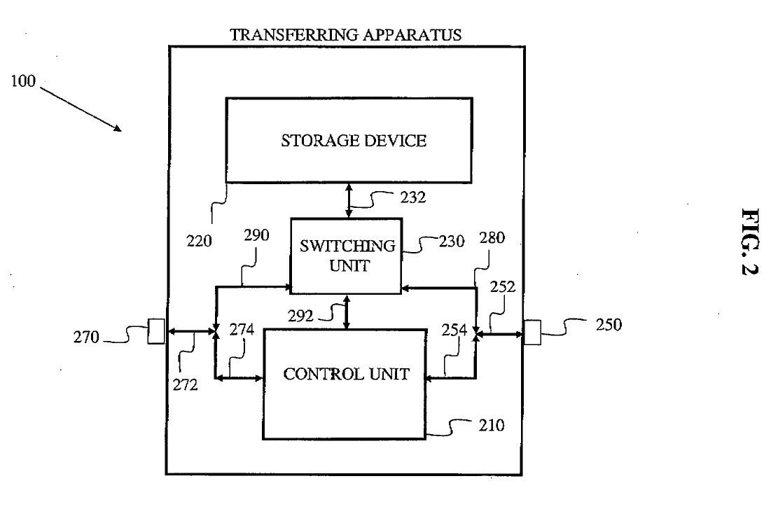

Referring now to FIG. 2, the basic inner structure of the transferring apparatus 100 is depicted in a form of a block diagram.

According to all embodiments of the invention, the transferring apparatus 100 is a device based exclusively on hardware components. It has an internal hardware-based control unit 210 that is connected to a switching unit 230. Said switching unit 230 is connected via a data link 232 to a storage device 220. Said switching unit 230 is further connected via a control link 292 to said control unit 210.

The transferring apparatus 100 is further equipped with two USB ports 250 and 270 respectively. Said first USB port 250 is connected to a USB line 252 which diverge into a data link 280 and a control link 254 respectively. Whereas said data link 280 connects said first USB port 250 to said storage unit 220 via said switching unit 230, said control link 254 connects said first USB port 250 to said control unit 210.

Similarly, said second USB port 270 is connected to a USB line 272 which diverge into a data link 290 and a control link 274 respectively. Whereas said data link 290 connects said second USB port 270 to said storage device 220 via said switching unit 230, said control link 274 connects said second USB port 270 to said control unit 210.

The detailed description above is required in order to stress the fundamental aspect of the invention, according to which, there are two distinct and isolated routes within the transferring apparatus 100: data route and control route. From a functional point of view, the switching unit 230 is simply switching the storage device 220 between the two USB ports 250 and 270 respectively according to the control signals.

According to one embodiment of the invention the transferring apparatus 100 operation does not rely on a software-based operating system (e.g. Windows or UNIX/Linux). This feature is the fundamental to the invention because it keeps the internal control of the transferring apparatus' 100 operation software-free. Thus it protects the transferring apparatus' 100 operation from external attackers focusing on software manipulations.

According to the preferred embodiment of the invention, the control unit 210 may be in the form of an integrated circuit (IC), either an ASIC or in the form of a programmable chip such as an FPGA. It is important to note that whereas the control unit 210 may be programmed in advance, the programming process is incorporated in hardware rather than in software, thus being irreversible and more important cannot be tempered with or prone to hackers' attacks. More so, potential hacker may reach the transferring apparatus 100 only through USB ports 250 and 270. Therefore he or she is blocked by means of hardware from reaching the control unit 210.

According to another aspect of the invention, the transferring apparatus 100 does not have any IP address, as it is never a component at any computer network, and so there are no regular way to connect to the apparatus, like using the TCP/IP protocol. This aspect further stress the advantage of the present invention in being protected versus communication networks hackers.

According to the preferred embodiment of the invention, the storage device 220 is a mass storage device such as a stand-alone flash memory drive, or a hard-drive. The use of a mass storage device comply with the general concept of the present invention according to which, at any given time, the mass storage device is either an integral component of computer B 120, or an integral component of computer A 110, or not connected at all (Idle state).

Advantageously, and following the mass storage devices principals (primarily flash memory drives) the present invention performs the data transference between the computers A 110 and B 120 by said storage device 220 according to the following process:
Move=Copy+Verify+Delete
According said process, data is first copied to the target file, then verified and finally deleted from the source file. Thus, data is backed in case there is any form of system failure.

According to one embodiment of the invention, whereas the connection and separation of the said storage device 220 is established on the hardware level, the overall control unit 210 may be managed by an external software application via the USB ports 250 and 270

It is important to stress that this software application is being held on another computer, and is not present in any of the communication apparatus components.

According to the preferred embodiment of the invention both computers A 110 and computer B 120 are connected to the transferring apparatus 100 via a USB line (or similar lines, such as Fire-wire) each.

Following is an example of a data transference procedure. In this example data is sent from computer A 110 to computer B 120, but the same applies to data transference in the other direction:
Computer A 110 orders the storage device 220 by sending a ‘PULL’ instruction;
The control unit 210 commands the switching unit 230 to establishes a physical connection between computer A 110 and the storage device 220;
The source file in computer A 110 is copied to a target file in the storage device 220 and verified;
The control unit 210 disconnects the a physical connection between computer A 110 and the storage device 220, and establishes a physical connection between computer B 120 and the storage device 220; and
The source file in the storage device 220 is copied to a target file in computer B 120, verified and finally deleted from the storage device 220.

On each of the computers A 110, B 120, there is a designated software application whose purposes are twofold: controlling the data transference procedure and timing the switching requests that are sent to the transferring apparatus 100. The data transference may be programmed to operate in a synchronous manner, in which data is transferred on a regular basis in predefined intervals, or in an asynchronous manner, in which data is transferred on demand. The data transference between computers A 110 and B 120 may also be defined as Bidirectional (symmetric) or Unidirectional (asymmetric). In the Bidirectional (symmetric) configuration data may be transferred both ways, and in the Unidirectional (asymmetric) configuration the data flows only in one direction (only from A 110 to B 120 or only from B 120 to A 110).

According to another aspect of the invention, the system administrator may determine data transferring preferences. While most of the preferences may be determined on the software level, the directionality of the data transference is determined internally on the hardware level using a physical switch and cannot be overridden by any software means. It is therefore safe from intervention attempts by any external attacker.

Additionally, the volume of data transferred each time may also be controlled by the system administrator. It is limited only by the size of said storage device 220 of apparatus 100. If required, it may be replaced with al external disk with any volume thus expanding the storage device 220.

Another aspect of the, invention relates to the fact that certain types of data transference methods are not easily divided into data segments that can be transferred individually. For example, Stream Control Transmission Protocol (SCTP) is a protocol for transmitting multiple streams of data at the same time between two end points that have established a connection in a network. In order to enable data transfer of said type in the present invention, software adds-on way be incorporated in the system for translating stream data like SMTP/POP3, HTTP, FTP, SNMP into data segments which may then be transferred in data chunks rather than continuously.

Similarly, on the receiving side a reverse conversion is performed, this time from data blocks to a contentious stream of bits. It should be noted that both conversions are transparent to the user.

It should be noted that other means of communication, such as Fax transference and SMS sending, may benefit from the present invention.

On another aspect of the invention, many other security software applications may be integrated into the operation of the apparatus in order to enhance the overall security level of the system.

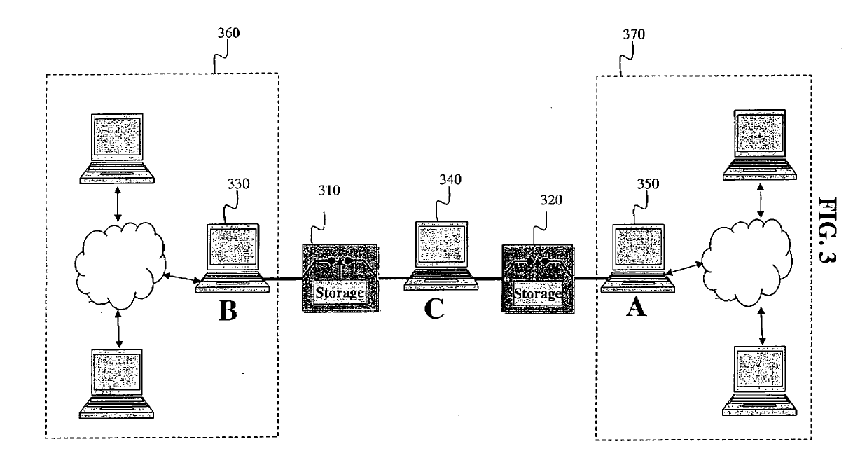

Referring now to FIG. 3, the configuration needed for security enhancement of the system is depicted. In this illustration, a third computer C 340 is connected as an intermediate station and may transfer data (through a physical switching) with computer A 350 on one end via a first transferring apparatus 320, and to computer B 330 on the other end, via a second transferring apparatus 310.

Similarly to FIG. 1, each of computers A 350 and computer B 330, may be parts of communication networks 370 and 360 respectively.

Once this configuration is set up, any intervening procedure may be executed on the transferred data. A content checker and filter, for instance, may be installed on computer C 340 to ensure that only predefined data type and content may be transferred between the computers A 350 and B 330. Any information that does not comply with the security definitions is filtered out. In addition, any form of anti virus/vandal software may scan any information transferred from computer A 350 to computer B 330, via computer C 340, and vice versa. In case infected data is identified the data transference is deleted and a virus alert is sent back to the transferring computer, or to the Chief Security Officer. In these cases, placing of the computer C 340 between the two transferring apparatuses 320 and 310, enables the security tools. (e.g. anti-virus/vandal, content filter/checker) to run in a sterile environment. Thus it functions as physical separation and a hardware-based DMZ (demilitarized zone). The critical work of the security tools is then protected from external attackers, and also from internal threats, such as a “Trojan horse”.

According to another aspect of the invention, higher data transfer rates may be achieved by connecting several transferring apparatuses 100 in parallel as a cluster. By applying this parallel configuration, larger portions of data may be transferred in parallel, corresponding to the total storage capacity of all parallel storage unites 220 and thus enhancing the data transfer rate. Using the parallel configuration also increase the availability of tile transference system.

According to another embodiment of the invention, due to security maintenance purposes, any activity of the apparatus is recorded in two types of log files: an administrative log which records all switching activity and a transference log which records information about the nature of the transferred data.

Following are a few examples for possible uses of the invention as it is described above. In general, the system and method enable secure networks to open in highly reliable communication interface, other than TCP/IP, with other network without jeopardizing their level of security. The system and method maybe used, for instance, for transferring emails between a highly secured network and the Internet. In this case, all communication between the secured system's mail server and the mail server of an Internet Service Provider flow through the apparatus. Due to the offline nature of email communication, the operation of the apparatus is totally transparent to the users in this case. Another example is in systems where alert messages (such as SMS) need to be sent out from a secure network to the Internet. The secure system may send alerts to designated addresses using the Internet, without exposing itself to malicious invasions from the outside environment. The apparatus can then be configured to transfer data only in one direction. This system and method may also be used for performing synchronizations between two servers whereas one server is a secure server and the other is unsecured and supplies information to Internet users.

Another example is the ability to update a sensitive network with downloaded information from the Internet, such as Anti-virus software updates, or system's patches, or drivers. This operation may be done automatically and according to a predetermined schedule.

Yet another possible use of the apparatus according to the present invention provides an off-line surfing service for a single user or secured intranet servers. A copy of the website is automatically transferred from the Internet to the user's local network or computer through the apparatus. Once the web-site copy is stored locally, it is available to the user. The management software application programmed to update the content of the website's copy in accordance with pre-determined schedule. Such service can be beneficial for organizations that prefer to remain unconnected to the Internet and still provide their users with access to specific Internet services and information.

What is claimed is:

1. A transferring hardware-based apparatus for secure transferring of data between a first computer and a second computer, said apparatus comprising:
at least one storage device;
at least one hardware-based switching unit enabling physical connection/disconnection between said storage device and one computer at a time enabling data transferring;
a hardware-based control unit logically separated from the operating systems of said computers for synchronizing said data transferring by controlling said switching unit.

2. A transferring hardware-based apparatus for secure transferring of data between a first computer of an isolated network and a second computer which is connected to an external non-secure network, said apparatus comprised of:
at least one storage device;
at least one hardware-based switching unit enabling physical connection/disconnection between said storage device and one computer at a time enabling data transferring;
a hardware-based control unit logically separated from the operating systems of said computers for synchronizing said data transferring by controlling said switching unit,

3. The apparatus of claim 1, wherein said apparatus is connected to said computers by single lines configured to deliver both data and control signals.

4. The apparatus of claim 1, wherein said apparatus is connected to said computers via USB lines.

5. The apparatus of claim 1, wherein said apparatus is connected to said computers via Fire wire lines.

6. The apparatus of claim 1, wherein said apparatus is connected to said computers via data lines and separated control lines.

7. The apparatus of claim 1, further including a translating module enabling to convert between different data transmission protocols of designated applications of the computers.

8. The apparatus of claim 1 including two separate storage devices, managed by two separated control units, and two separated switching units, further comprising a processing unit located in between the two storage devices, wherein each storage device is connected each time through one switching unit to one computer and the transferred data is analyzed and managed by said processing unit.

9. The apparatus of claim 1, wherein the storage device is a mass storage device, wherein said mass storage device is identified with the computer that is currently connected to the apparatus by the switching unit.

10. The apparatus of claim 1, wherein the storage device, upon connection to a first computer, becomes an intergal part of said first computer and wherein said storage device has no connection to the second computer as long as it is connected to said first computer.

11. The apparatus of claim 1, wherein the storage device is a flash based drive.

12. The apparatus of claim 1, wherein the storage device is a magnetic hard disk drive.

13. The apparatus of claim 1, wherein said apparatus is configured to transfer data in a unidirectional manner, from said first computer to said second computer but does not transfer any data from said second computer to said first computer.

14. A system for enhancing data transfer security wherein a first apparatus of claim I is connected to a second apparatus of claim 1 via a third computer, and wherein said third computer is configured to analyze, monitor and fix data transferred from first apparatus of claim 1 to second apparatus of claim 1.

15. A system for enhancing data transfer rate wherein the a first apparatus of claim 1 is connected in parallel to a second apparatus of claim 1, and wherein said system is functioned to enhance data transfer rate between the two computers.
